(19) United States
(12) Patent Application Publication
(10) Pub. No.: US 2017/0083163 A1
(43) Pub. Date: Mar. 23, 2017

(54) TOUCH DISPLAY CIRCUIT AND DRIVING METHOD THEREOF, DISPLAY APPARATUS

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Hongjuan LIU, Beijing (CN); Haisheng WANG, Beijing (CN); Xiaochuan CHEN, Beijing (CN); Shengji YANG, Beijing (CN); Yingming LIU, Beijing (CN); Xiaoliang DING, Beijing (CN); Weijie ZHAO, Beijing (CN); Changfeng LI, Beijing (CN); Wei LIU, Beijing (CN)

(21) Appl. No.: 15/133,686

(22) Filed: Apr. 20, 2016

(30) Foreign Application Priority Data
Sep. 22, 2015 (CN) 201510609650.0

(51) Int. Cl. G06F 3/042; G09G 3/3291; G09G 3/3266; G06F 3/041

(52) U.S. Cl. CPC G06F 3/0421; G06F 3/0412; G09G 3/3291; G09G 3/3266; G06F 2203/04101; G06F 2203/04103; G09G 2300/0819

(57) ABSTRACT

Provided are a touch display circuit and driving method thereof, and a display apparatus. The touch display circuit comprises: a reset module connected to a reset signal terminal, a first level terminal and a first node; a charging module connected to a gate signal terminal, a data signal terminal and a second node; a pull-up module connected to a second level terminal, a first scan signal terminal, the first node and the second node; a driving module connected to the second level terminal, the gate signal terminal, the first node and a third node; and an electroluminescent module connected to the third node, a second scan signal terminal and a third level terminal. The touch display circuit outputs stable driving current and avoids or reduces the influence of the opposite electrodes on the touch driving.

### TECHNICAL FIELD OF THE DISCLOSURE

The present disclosure relates to a touch display circuit and driving method thereof, and a display apparatus.

### BACKGROUND

OLED (Organic Light-Emitting Diode) is one of the hot spots currently in the research area of flat panel display. Compared with conventional LCD (Liquid Crystal Display), OLED has advantages such as low power consumption, low manufacturing cost, self-illumination, wide angle of sight and fast response speed, among others. At present, OLED has begun to replace conventional LCD in the display area of cell phones, PDAs (Personal Digital Assistants), digital cameras or the like.

Currently, there is a trend to apply the In Cell Touch technology to OLED, that is, integrate touch electrodes inside an OLED, saving the procedure of separately fabricating touch electrodes, such that the OLED is improved in many aspects such as manufacturing process, manufacturing cost, display screen thickness, and so on. The solution of integrating touch electrodes inside an OLED is segmenting and reusing the cathode layer of the OLED as touch electrodes, and fabricating conducting lines with the metal layer in the TFT (Thin Film Transistor) area under the cathode layer, wherein touch driving signals are transmitted to the cathode layer reused as the touch electrodes through the conducting lines. The driving method is dividing the time of one frame into a display stage and a touch stage during the touch display procedure, providing a common voltage signal to the cathode layer during the display stage, and providing a touch driving signal to the cathode layer during the touch stage. However, in contrast to the conventional LCD which uses stable voltage to control the brightness. OLED is driven by current, which needs stable current to control light emitting. In addition, in such a solution that combines the In Cell Touch technology with OLED, the capacitance load between the touch electrodes and their opposite electrodes such as the OLED anode layer and pixel control signal lines inside the OLED would be very large, which then influences the touch driving.

### SUMMARY

At least one embodiment of the present disclosure provides a touch display circuit, a touch display method and a display apparatus to output stable driving current and avoid or reducing the influence of opposite electrodes on the touch driving.

According to a first aspect of the present disclosure, there is provided a touch display circuit comprising a reset module, a charging module, a pull-up module, a driving module and an electroluminescent module.

The reset module is connected to a reset signal terminal, a first level terminal and a first node; the charging module is connected to a gate signal terminal, a data signal terminal and a second node; the pull-up module is connected to a second level terminal, a first scan signal terminal, the first node and the second node; the driving module is connected to the second level terminal, the gate signal terminal, the first node and a third node; and the electroluminescent module is connected to the third node, a second scan signal terminal and a third level terminal.

During a display stage, the reset module is configured to pull the voltage of the first node to be equal to the voltage of the first level terminal under the control of a reset signal input by the reset signal terminal; the charging module is configured to pull the voltage of the second node to be equal to the voltage of the data signal terminal under the control of a gate signal input by the gate signal terminal and a data signal input by the data signal terminal; the pull-up module is configured to pull the voltage of the second node to be equal to the voltage of the second level terminal under the control of a first scan signal input by the first scan signal terminal, and make the voltage of the first node leap; the driving module is configured to pull the voltage of the first node to be equal to the voltage of the third node under the control of the gate signal input by the gate signal terminal, or output a driving current through the third node under the control of a voltage input by the second level terminal and the voltage of the first node; the electroluminescent module is configured to display a gray scale through the driving current under the control of a second scan signal input by the second scan signal terminal.

During a touch stage, the gate signal terminal, the data signal terminal, the reset signal terminal, the first scan signal terminal and the second scan signal terminal input a touch driving signal, and the electroluminescent module stops displaying the gray scale under the control of the touch driving signal input by the second scan signal terminal.

Optionally, the reset module comprises a first transistor; and

a first terminal of the first transistor is connected to the first node, a second terminal of the first transistor is connected to the first level terminal, and a gate of the first transistor is connected to the reset signal terminal.

Optionally, the charging module comprises a second transistor; and

a first terminal of the second transistor is connected to the second node, a second terminal of the second transistor is connected to the data signal terminal, and a gate of the second transistor is connected to the gate signal terminal.

Optionally, the pull-up module comprises a third transistor and a capacitor;

a first terminal of the third transistor is connected to the second level terminal, a second terminal of the third transistor is connected to the second node, and a gate of the third transistor is connected to the first scan signal terminal; and

a first electrode of the capacitor is connected to the second node, and a second electrode of the capacitor is connected to the first node.

Optionally, the driving module comprises a fourth transistor and a fifth transistor;

a first terminal of the fourth transistor is connected to the second level terminal, a second terminal of the fourth transistor is connected to the third node, and a gate of the fourth transistor is connected to the first node; and

a first terminal of the fifth transistor is connected to the first node, a second terminal of the fifth transistor is connected to the third node, and a gate of the fifth transistor is connected to the gate signal terminal.

Optionally, the electroluminescent module comprises a sixth transistor and an OLED;

a first terminal of the sixth transistor is connected to the third node, a second terminal of the sixth transistor is connected to an anode of the OLED, and a gate of the sixth transistor is connected to the second scan signal terminal; and

a cathode of the OLED is connected to the third level terminal.

Optionally, the third level terminal is a grounded level terminal.

Optionally, all transistors are N type transistors; or all transistors are P type transistors.

According to a second aspect of the present disclosure, there is provided a driving method for the touch display circuit described in the above, comprising:

during a first stage, the reset module pulling the voltage of the first node to be equal to the voltage of the first level terminal under the control of a reset signal input by the reset signal terminal;

during a second stage, the charging module pulling the voltage of the second node to be equal to the voltage of the data signal terminal under the control of a gate signal input by the gate signal terminal, and the driving module pulling the voltage of the first node to be equal to the voltage of the third node under the control of the gate signal input by the gate signal terminal;

during a third stage, the pull-up module pulling the voltage of the second node to be equal to a voltage of the second level terminal under the control of a first scan signal input by the first scan signal terminal, and making the voltage of the first node leap;

during a fourth stage, the driving module outputting a driving current through the third node under the control of the voltage input by the second level terminal and the voltage of the first node, and the electroluminescent module displaying a gray scale through the driving current under the control of a second scan signal input by the second scan signal terminal;

during a fifth stage, the gate signal terminal, the data signal terminal, the reset signal terminal, the first scan signal terminal and the second scan signal terminal inputting a touch driving signal, and the electroluminescent module stopping displaying the gray scale under the control of the touch driving signal input by the second scan signal terminal.

According to a third aspect of the present disclosure, there is provided a display apparatus comprising the touch display circuit described in the above.

Embodiments of the present disclosure provide a touch display apparatus and driving method thereof, and a display apparatus. During the display stage, it is possible that the reset module first pulls the voltage of the first node to be equal to the voltage of the first level terminal, then the charging module pulls the voltage of the second node to be equal to the voltage of the data signal terminal and the driving module pulls the voltage of the first node to be equal to the voltage of the third node, then the pull-up module pulls the voltage of the second node to be equal to the voltage of the second level terminal and makes the voltage of the first node leap, and then the driving module outputs a driving current and the electroluminescent module displays a gray scale through the driving current; therefore, in the display stage, it is possible to output stable driving current. During the touch stage, the gate signal terminal, the data signal terminal, the reset signal terminal, the first scan signal terminal and the second scan signal terminal input a touch driving signal, and the electroluminescent module stops displaying the gray scale under the control of the touch driving signal input by the second scan signal terminal; therefore, during the touch stage, the anode layer of the electroluminescent module is in a floating state, and thus it is possible to reduce the capacitance load between the touch electrodes and the anode layer of the electroluminescent module. In addition, since the gate signal terminal, the data signal terminal, the reset signal terminal, the first scan signal terminal and the second scan signal terminal input a touch driving signal, it is possible to reduce the capacitance load between each display driving signal line and the touch electrodes. Therefore, embodiments of the present disclosure can output stable driving current and avoid or reduce the influence of the opposite electrodes on the touch driving.

### BRIEF DESCRIPTION OF THE DRAWINGS

FIG. 1 is a schematic diagram of the structure of an In Cell Touch OLED provided by an embodiment of the present disclosure;

FIG. 2 is a schematic diagram of the structure of a touch display circuit provided by an embodiment of the present disclosure;

FIG. 3 is a circuit diagram of a touch display circuit provided by an embodiment of the present disclosure;

FIG. 4 is a flowchart of steps of a touch driving method provided by an embodiment of the present disclosure; and

FIG. 5 is a time sequence state diagram of signals in a touch display circuit provided by an embodiment of the present disclosure.

### DETAILED DESCRIPTION

In the following, technical solutions in embodiments of the present disclosure are clearly and completely described in connection with figures in the embodiments of the present disclosure. Obviously, the described embodiments are only part but not all of the embodiments of the present disclosure. Based on the embodiments in the present disclosure, all other embodiments obtained by those skilled in the art without creative work fall within the protection scope of the present disclosure.

The transistors employed in all embodiments of the present disclosure can be TFTs (Thin Film Transistors), FETs (Field Effect Transistors) or any other devices with the same characteristics. According to their functions in the circuit, the transistors employed in the embodiments of the present disclosure mainly comprise switch transistors and driving transistors. Since the source and drain of the switch transistors used herein are symmetrical, their source and drain are exchangeable. In embodiments of the present disclosure, in order to distinguish the two electrodes other than the gate of the transistors, one of them is referred to as the source, and the other is referred to as the drain. According to the form shown in the figures, it is prescribed that the middle terminal of a transistor is the gate, the signal input terminal is the source, and the signal output terminal is the drain. In addition, the switch transistors employed in embodiments of the present disclosure comprise two types which are P type switch transistors and N type switch transistors, wherein the P type switch transistor is turned on when its gate is in a low level and turned off when its gate is in a high level, and the N type switch transistor is turned on when its gate is in a high level and turn off when its gate is in a low level. The driving transistors comprise P type driving transistors and N type driving transistors, wherein the P type driving transistor is in an amplification state or a saturation state when the gate voltage is a low level (the gate voltage is lower than he source voltage) and the absolute value of the voltage difference between the gate and the source is larger than a threshold voltage, and the N type driving transistor is in an amplification state or a saturation state when the gate voltage is a high level (the gate voltage is larger than he source voltage) and the absolute value of the voltage difference between the gate and the source is larger than a threshold voltage.

It is also noted that the touch display circuits provided by embodiments of the present disclosure are used for driving In Cell Touch OLEDs. FIG. 1 is a schematic diagram of the structure of an In Cell Touch OLED provided by an embodiment of the present disclosure. Referring to FIG. 1, the In Cell Touch OLED comprises a substrate 10, an anode layer 11, a light emitting layer 12, a cathode layer 13 and an array layer 14. The cathode layer 13 is located above the light emitting layer 12, and the anode layer 11 is located below the light emitting layer 12. The structure formed by the cathode layer 13, the anode layer 11 and the light emitting layer 13 is the OLED structure in the following embodiments, wherein the anode layer of the In Cell Touch OLED is equivalent to the anode of the OLED, and the cathode layer of the In Cell Touch OLED is equivalent to the cathode of the OLED. The cathode layer 13 of the In Cell Touch OLED is segmented into multiple mutually independent electrodes each of which inputs a touch driving signal through a conducting line in the array layer. During the touch display driving procedure, a time division manner is used to perform driving, that is, one frame of time is divided into a display stage and a touch stage, wherein during the display stage, a common voltage signal is provided to the cathode layer 13 and a display driving signal is provided to the anode layer, and during the touch stage, a touch driving signal is provided to the cathode layer. Since the capacitance between the touch electrodes and anode layer and the capacitance between the touch electrodes and the display driving signal lines have large influence on the touch sensitivity and the touch driving frequency, if the opposite electrodes of the driving electrodes are also enabled to input touch driving signals during the touch stage, it is possible to reduce the capacitance between the touch electrodes and the opposite electrodes. On the other hand, in order to ensure normal display, stable current needs to be able to be output to the anode layer during both the display stage and the touch stage. In view of the above, a touch display circuit and driving method thereof and a display apparatus provided by embodiment of the present disclosure are designed.

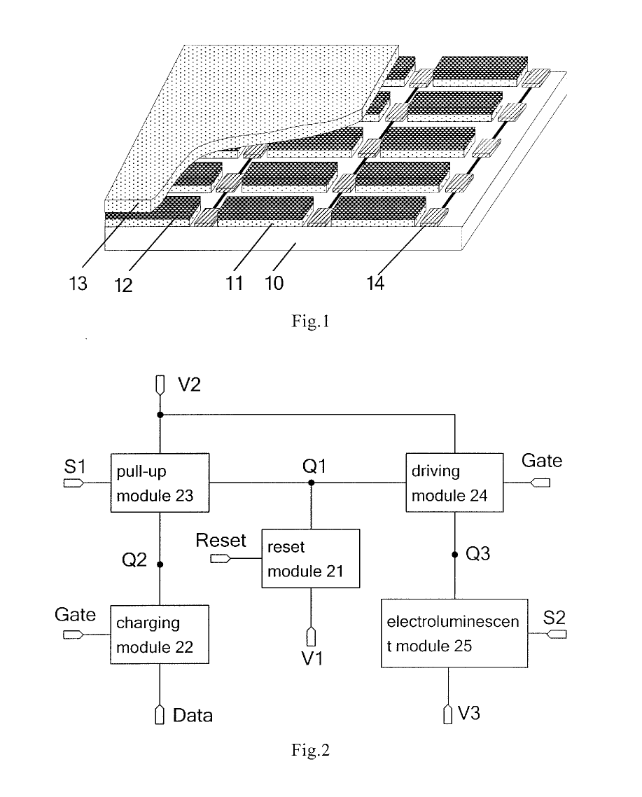

FIG. 2 is a schematic diagram of the structure of a touch display circuit provided by an embodiment of the present disclosure. Referring to FIG. 2, the touch display circuit comprises: a reset module 21, a charging module 22, a pull-up module 23, a driving module 24 and an electroluminescent module 25.

The reset module 21 is connected to a reset signal terminal Reset, a first level terminal V1 and a first node Q1; the charging module 22 is connected to a gate signal terminal Gate, a data signal terminal Data and a second node Q2; the pull-up module 23 is connected to a second level terminal V2, a first scan signal terminal S1, the first node Q1 and the second node Q2; the driving module 24 is connected to the second level terminal V2, the gate signal terminal Gate, the first node Q1 and a third node Q3; and the electroluminescent module 25 is connected to the third node Q3, a second scan signal terminal S2 and a third level terminal V3.

During a display stage, the reset module 21 is used to pull the voltage of the first node Q1 to be equal to the voltage of the first level terminal V1 under the control of a reset signal input by the reset signal terminal Reset; the charging module 22 is used to pull the voltage of the second node Q2 to be equal to the voltage of the data signal terminal Data under the control of a gate signal input by the gate signal terminal Gate and a data signal input by the data signal terminal Data; the pull-up module 23 is used to pull the voltage of the second node Q2 to be equal to the voltage of the second level terminal V2 under the control of a first scan signal input by the first scan signal terminal S1, and make the voltage of the first node Q1 leap; the driving module 24 is used to pull the voltage of the first node Q1 to be equal to the voltage of the third node Q3 under the control of the gate signal input by the gate signal terminal Gate, or output a driving current through the third node Q3 under the control of a voltage input by the second level terminal V2 and the voltage of the first node Q1; the electroluminescent module 25 is used to display a gray scale through the driving current under the control of a second scan signal input by the second scan signal terminal S2.

During a touch stage, the gate signal terminal Gate, the data signal terminal Data, the reset signal terminal Reset, the first scan signal terminal S1 and the second scan signal terminal S2 input a touch driving signal, and the electroluminescent module 25 stops displaying the gray scale under the control of the touch driving signal input by the second scan signal terminal S2.

During the display stage, it is possible that the reset module first pulls the voltage of the first node to be equal to the voltage of the first level terminal, then the charging module pulls the voltage of the second node to be equal to the voltage of the data signal terminal and the driving module pulls the voltage of the first node to be equal to the voltage of the third node, then the pull-up module pulls the voltage of the second node to be equal to the voltage of the second level terminal and makes the voltage of the first node leap, and then the driving module outputs a driving current and the electroluminescent module displays a gray scale through the driving current; therefore, in the display stage, it is possible to output stable driving current. During the touch stage, the gate signal terminal, the data signal terminal, the reset signal terminal, the first scan signal terminal and the second scan signal terminal input a touch driving signal, and the electroluminescent module stops displaying the gray scale under the control of the touch driving signal input by the second scan signal terminal; therefore, during the touch stage, the anode layer of the electroluminescent module is in a floating state, and thus it is possible to reduce the capacitance load between the touch electrodes and the anode layer of the electroluminescent module. In addition, since the gate signal terminal, the data signal terminal, the reset signal terminal, the first scan signal terminal and the second scan signal terminal input a touch driving signal, it is possible to reduce the capacitance load between each display driving signal line and the touch electrodes. Therefore, embodiments of the present disclosure can output stable driving current and avoid or reduce the influence of the opposite electrodes on the touch driving.

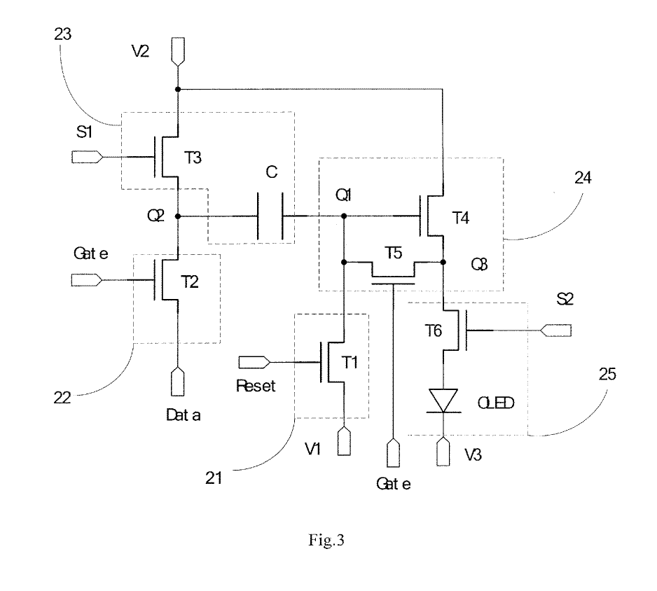

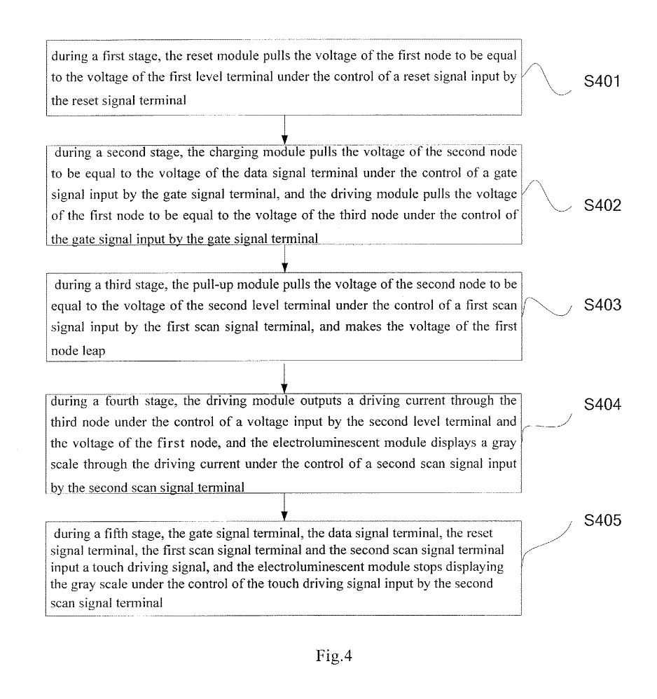

FIG. 3 is a circuit diagram of a touch display circuit provided by an embodiment of the present disclosure. For example, referring to FIG. 3, the reset module 21 comprises a first transistor T1.

A first terminal of the first transistor T1 is connected to the first node Q1, a second terminal of the first transistor T1 is connected to the first level terminal V1, and a gate of the first transistor T1 is connected to the reset signal terminal Reset.

The charging module 22 comprises a second transistor T2.

A first terminal of the second transistor T2 is connected to the second node Q2, a second terminal of the second transistor T2 is connected to the data signal terminal Data, and a gate of the second transistor T2 is connected to the gate signal terminal Gate.

The pull-up module 23 comprises a third transistor T3 and a capacitor C.

A first terminal of the third transistor T3 is connected to the second level terminal V2, a second terminal of the third transistor T3 is connected to the second node Q2, and a gate of the third transistor T3 is connected to the first scan signal terminal S1.

A first electrode of the capacitor C is connected to the second node Q2, and a second electrode of the capacitor C is connected to the first node Q1.

The driving module 24 comprises a fourth transistor T4 and a fifth transistor T5.

A first terminal of the fourth transistor T4 is connected to the second level terminal V2, a second terminal of the fourth transistor T4 is connected to the third node Q3, and a gate of the fourth transistor T4 is connected to the first node Q1.

A first terminal of the fifth transistor T5 is connected to the first node Q1, a second terminal of the fifth transistor T5 is connected to the third node Q3, and a gate of the fifth transistor T5 is connected to the gate signal terminal Gate.

The electroluminescent module 25 comprises a sixth transistor T6 and an OLED.

A first terminal of the sixth transistor T6 is connected to the third node Q3, a second terminal of the sixth transistor T6 is connected to an anode of the OLED, and a gate of the sixth transistor T6 is connected to the second scan signal terminal S2.

A cathode of the OLED is connected to the third level terminal.

FIG. 4 is a flowchart of steps of a touch driving method provided by an embodiment of the present disclosure. Referring to FIG. 4, the driving method comprises the following steps.

At S401, during a first stage, the reset module pulls the voltage of the first node to be equal to the voltage of the first level terminal under the control of a reset signal input by the reset signal terminal;

At S402, during a second stage, the charging module pulls the voltage of the second node to be equal to the voltage of the data signal terminal under the control of a gate signal input by the gate signal terminal, and the driving module pulls the voltage of the first node to be equal to the voltage of the third node under the control of the gate signal input by the gate signal terminal.

At 403, during a third stage, the pull-up module pulls the voltage of the second node to be equal to the voltage of the second level terminal under the control of a first scan signal input by the first scan signal terminal, and makes the voltage of the first node leap;

At 404, during a fourth stage, the driving module outputs a driving current through the third node under the control of the voltage input by the second level terminal and the voltage of the first node, and the electroluminescent module displays a gray scale through the driving current under the control of a second scan signal input by the second scan signal terminal;

At 405, during a fifth stage, the gate signal terminal, the data signal terminal, the reset signal terminal, the first scan signal terminal and the second scan signal terminal input a touch driving signal, and the electroluminescent module stops displaying the gray scale under the control of the touch driving signal input by the second scan signal terminal.

According to the driving method for a touch display circuit provided by an embodiment of the present disclosure, the reset module first pulls the voltage of the first node to be equal to the voltage of the first level terminal, then the charging module pulls the voltage of the second node to be equal to the voltage of the data signal terminal and the driving module pulls the voltage of the first node to be equal to the voltage of the third node, then the pull-up module pulls the voltage of the second node to be equal to the voltage of the second level terminal and makes the voltage of the first node leap, and then the driving module outputs a driving current and the electroluminescent module displays a gray scale through the driving current; therefore, in the display stage, it is possible to output stable driving current. After the driving current drives to display a gray scale, the gate signal terminal, the data signal terminal, the reset signal terminal, the first scan signal terminal and the second scan signal terminal input a touch driving signal, and the electroluminescent module stops displaying the gray scale under the control of the touch driving signal input by the second scan signal terminal; therefore, during the touch stage, the anode layer of the electroluminescent module is in a floating state, and thus it is possible to reduce the capacitance load between the touch electrodes and the anode layer of the electroluminescent module. In addition, since the gate signal terminal, the data signal terminal, the reset signal terminal, the first scan signal terminal and the second scan signal terminal input a touch driving signal, it is possible to reduce the capacitance load between each display driving signal line and the touch electrodes. Therefore, embodiments of the present disclosure can output stable driving current and avoid or reduce the influence of the opposite electrodes on the touch driving.

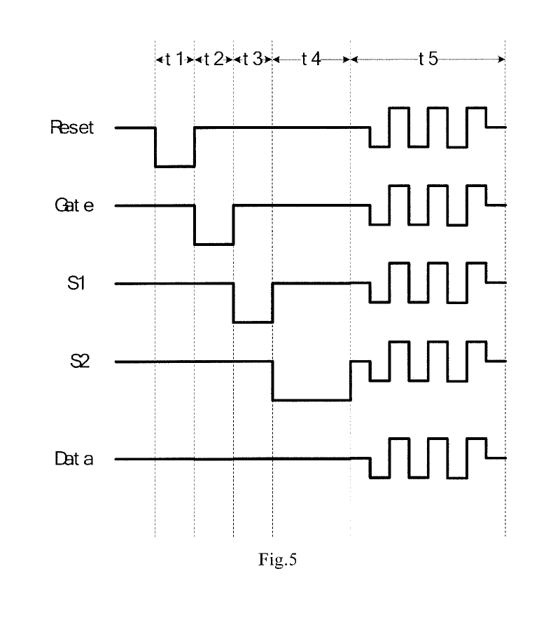

FIG. 5 is a time sequence state diagram of signals in a touch display circuit provided by an embodiment of the present disclosure. In the following, referring to the schematic time sequence state diagram shown in FIG. 5, the operation principle of the touch display circuit shown in FIG. 3 and the touch driving method shown in FIG. 4 will be described. Description is made by taking an example that all the transistors in the circuit shown in FIG. 3 are P type transistors. The first transistor T1, the second transistor T2, the third transistor T3, the fifth transistor T5 and the sixth transistor T6 are switch transistors, and the fourth transistor T4 is a driving transistor. FIG. 5 shows the time sequence state of the reset signal of the reset signal terminal Reset, the gate signal of the gate signal terminal Gate, the first scan signal of the first scan signal terminal S1, the second scan signal of the second scan signal terminal S2 and the data signal of the data signal terminal Data. The first level terminal V1, the second level terminal V2 and the third level terminal V3 provide stable voltages. The first level terminal V1 and the third level terminal V3 provide a low level VGL, and the second level terminal V2 provides a high level VGH. Exemplarily, the first level terminal V1 and the third level terminal V3 can be grounded; or the first level terminal V1 provides an initial voltage value of low level, and the third level terminal V3 is grounded. As shown in FIG. 5, the time sequence states of five stages are provided, comprising the first stage t1, the second stage t2, the third stage t3, the fourth stage t4 and the fifth stage t5.

At stage t1, Reset is at a low level, Gate, Data, S1 and S2 are at a high level respectively, the first transistor T1 is turned on, and the other transistors are all turned off at this stage. At this stage, the first node Q1 is electrically connected with the first level terminal V1 through the transistor T1 to reset the level of the first node Q1 to an initial value. Therefore, stage t1 is referred to as a reset stage.

At stage t2, Gate is at a low level, Reset, Data, S1 and S2 are at a high level respectively, the second transistor T2, the fourth transistor T4 and the fifth transistor T5 are turned on, and all the other transistors are turned off at this stage. At this stage, the data signal terminal Data is connected with the second node Q2 through the second transistor T2, and a data signal input by the data signal terminal Data charges the capacitor C connected to the second node Q2. At the same time, the other terminal of the capacitor C connected to the first node Q1 is floated, so the level of the first node Q1 increases. Further, since Gate is at a low level, the transistor T5 is turned on, and thus the second level terminal V2 charges the other terminal of the capacitor C through the driving transistor T4 and the fifth transistor T5. The level of the first node Q1 is the same as the level of the third node Q3. Stage t2 is referred to as a charging stage.

At stage t3, S1 is at a low level, Reset, Data, Gate and S2 are at a high level respectively, the third transistor T3 is turned on, and all the other transistors are turned off at this stage. At this stage, the second level terminal V2 is connected with the second node Q2 through the third transistor T3, and the level of the first terminal of the capacitor C is further pulled up. At the same time, since the second terminal of the capacitor C is floated and the capacitor has the characteristic of remaining the level difference between its two terminals unchanged, the voltage of the second terminal of the capacitor C leaps and the level of the first node is pulled up. Stage t3 is referred to as a compensation and leaping stage.

At stage t4, S2 is at a low level, Reset, Data, Gate and S1 are at a high level respectively, the sixth transistor T6 is turned on, and all the other transistors are turned off. At this stage, although stage t3 further pulls up the level of the first node Q1, the gate voltage of the driving transistor T4 is still smaller than the source voltage; therefore, the driving transistor T4 is turned on sufficiently and the second scan signal turns on the sixth transistor T6. Therefore, at this stage, the second level terminal V2 outputs a driving current to the OLED through the third node Q3, and the OLED displays a gray scale through the driving current. Stage t4 is referred to as a light emitting stage. In addition, the above stages t1-t4 in combination are referred to as a display stage.

At stage t5, the level of S2 is pulled up, the sixth transistor T6 is turned off, the displaying of gray scales is stopped, a black frame is inserted into the display picture, and Reset, Data, Gate, S1 and S2 input a touch driving signal respectively. Since T6 is turned off, the anode of the OLED is at a floating state at this stage, that is, the anode layer opposite to the cathode layer of the OLED is at the floating state; therefore, it is possible to reduce the capacitance load between the cathode layer and the anode layer of the OLED. At the same time, since Reset, Data, Gate, S1 and S2 all input a touch driving signal, it is possible to reduce the capacitance load between each display driving signal line and the cathode layer of the OLED. Stage t5 is referred to a touch stage.

The time from stage t1 until the first signal input terminal Input 1 of the present stage of touch display circuit inputs a low level again is taken as one complete operation period of the present stage of touch display circuit. The length of the display stage depends on the length the fourth stage t4, and the length of the touch stage depends on the length of the fifth stage t5. Embodiments of the present disclosure do not define the lengths of the display stage and the touch stage, and do not define the ratio between the length of the display stage and the length of the touch stage, either.

It is noted that, in order to achieve the above time sequence signals output by respective signal terminals, it is also needed to accordingly adjust the GOA (Gate driver On Array), and it is also needed to superimpose a modulation signal on the signal output by the GOA at stage t5 to make the GOA output signal be the same as the driving signal.

It is also noted that all the transistors in the touch display circuit provided by the above embodiments can also be N type transistors that are turned on by a high level. If all the transistors are N type transistors, it suffices to re-adjust the time sequence state of respective input signals in the touch display circuit. For example, the first level terminal V1 is adjusted to provide a high level, the reset signal Reset at stage t1 in FIG. 5 is adjusted to a high level, the other time sequence signals at stage t1 are adjusted to a low level, and each time sequence signal at the other stages is also adjusted to a time sequence signal with reverse phase.

Further, the above touch display circuit can also employ both N type transistors and P type transistors. Now, it needs to ensure that the transistors controlled by the same time sequence signal or voltage in the touch display circuit are of the same type. Of course, this is a reasonable alternative solution which can be made by those skilled in the art based on embodiments of the present disclosure, which thus should fall in the protection scope of the present disclosure. However, considering the manufacturing process of transistors, since the active layers of different types of transistors use different dopant materials, using the same type of transistors in the touch display circuit is more advantageous for the manufacturing process of the touch display circuit.

An embodiment of the present disclosure provides a display apparatus comprising a touch display circuit provided by any of the above embodiments.

Exemplarily, the display apparatus can be any product or component with display function such as electronic paper, a cell phone, a flat panel computer, a television, a display, a notebook computer, a digital photo frame, a navigator or the like.

According to the touch display circuit of the display apparatus provided by an embodiment of the present disclosure, during the display stage, it is possible that the reset module first pulls the voltage of the first node to be equal to the voltage of the first level terminal, then the charging module pulls the voltage of the second node to be equal to the voltage of the data signal terminal and the driving module pulls the voltage of the first node to be equal to the voltage of the third node, then the pull-up module pulls the voltage of the second node to be equal to the voltage of the second level terminal and makes the voltage of the first node leap, and then the driving module outputs a driving current and the electroluminescent module displays a gray scale through the driving current; therefore, in the display stage, it is possible to output stable driving current. During the touch stage, the gate signal terminal, the data signal terminal, the reset signal terminal, the first scan signal terminal and the second scan signal terminal input a touch driving signal, and the electroluminescent module stops displaying the gray scale under the control of the touch driving signal input by the second scan signal terminal; therefore, during the touch stage, the anode layer of the electroluminescent module is in a floating state, and thus it is possible to reduce the capacitance load between the touch electrodes and the anode layer of the electroluminescent module. In addition, since the gate signal terminal, the data signal terminal, the reset signal terminal, the first scan signal terminal and the second scan signal terminal input a touch driving signal, it is possible to reduce the capacitance load between each display driving signal line and the touch electrodes. Therefore, embodiments of the present disclosure can output stable driving current and avoid or reduce the influence of the opposite electrodes on the touch driving.

The above descriptions are only exemplary embodiments of the present disclosure, but are not used to limit the present disclosure. Any modification or replacement that can be easily thought of by those skilled in the art within the scope of the technical disclosed in the present disclosure should fall within the protection scope of the present disclosure. Therefore, the protection scope of the present disclosure should be defined by the protection scope of the claims.

What is claimed is:

1. A touch display circuit comprising:
a reset module connected to a reset signal terminal, a first level terminal and a first node;
a charging module connected to a gate signal terminal, a data signal terminal and a second node;
a pull-up module connected to a second level terminal, a first scan signal terminal, the first node and the second node;
a driving module connected to the second level terminal, the gate signal terminal, the first node and a third node; and
an electroluminescent module connected to the third node, a second scan signal terminal and a third level terminal.

2. The circuit according to claim 1, wherein
during a display stage, the reset module is configured to pull the voltage of the first node to be equal to the voltage of the first level terminal under the control of a reset signal input by the reset signal terminal; the charging module is configured to pull the voltage of the second node to be equal to the voltage of the data signal terminal under the control of a gate signal input by the gate signal terminal and a data signal input by the data signal terminal; the pull-up module is configured to pull the voltage of the second node to be equal to the voltage of the second level terminal under the control of a first scan signal input by the first scan signal terminal, and make the voltage of the first node leap; the driving module is configured to pull the voltage of the first node to be equal to the voltage of the third node under the control of the gate signal input by the gate signal terminal, or output a driving current through the third node under the control of a voltage input by the second level terminal and the voltage of the first node; the electroluminescent module is configured to display a gray scale through the driving current under the control of a second scan signal input by the second scan signal terminal;
during a touch stage, the gate signal terminal, the data signal terminal, the reset signal terminal, the first scan signal terminal and the second scan signal terminal input a touch driving signal, and the electroluminescent module stops displaying the gray scale under the control of the touch driving signal input by the second scan signal terminal.

3. The circuit according to claim 2, wherein the reset module comprises a first transistor; and
a first terminal of the first transistor is connected to the first node, a second terminal of the first transistor is connected to the first level terminal, and a gate of the first transistor is connected to the reset signal terminal.

4. The circuit according to claim 2, wherein the charging module comprises a second transistor; and
a first terminal of the second transistor is connected to the second node, a second terminal of the second transistor is connected to the data signal terminal, and a gate of the second transistor is connected to the gate signal terminal.

5. The circuit according to claim 2, wherein the pull-up module comprises a third transistor and a capacitor;
a first terminal of the third transistor is connected to the second level terminal, a second terminal of the third transistor is connected to the second node, and a gate of the third transistor is connected to the first scan signal terminal; and
a first electrode of the capacitor is connected to the second node, and a second electrode of the capacitor is connected to the first node.

6. The circuit according to claim 2, wherein the driving module comprises a fourth transistor and a fifth transistor;
a first terminal of the fourth transistor is connected to the second level terminal, a second terminal of the fourth transistor is connected to the third node, and a gate of the fourth transistor is connected to the first node; and
a first terminal of the fifth transistor is connected to the first node, a second terminal of the fifth transistor is connected to the third node, and a gate of the fifth transistor is connected to the gate signal terminal.

7. The circuit according to claim 2, wherein the electroluminescent module comprises a sixth transistor and an OLED;
a first terminal of the sixth transistor is connected to the third node, a second terminal of the sixth transistor is connected to an anode of the OLED, and a gate of the sixth transistor is connected to the second scan signal terminal; and
a cathode of the OLED is connected to the third level terminal.

8. The circuit according to claim 2, wherein the third level terminal is a grounded level terminal.

9. The circuit according to claim 3, wherein all transistors are N type transistors; or all transistors are P type transistors.

10. A driving method for the touch display circuit according to claim 1, comprising:
during a first stage, the reset module pulling the voltage of the first node to be equal to the voltage of the first level terminal under the control of a reset signal input by the reset signal terminal;
during a second stage, the charging module pulling the voltage of the second node to be equal to the voltage of the data signal terminal under the control of a gate signal input by the gate signal terminal, and the driving module pulling the voltage of the first node to be equal to the voltage of the third node under the control of the gate signal input by the gate signal terminal;
during a third stage, the pull-up module pulling the voltage of the second node to be equal to the voltage of the second level terminal under the control of a first scan signal input by the first scan signal terminal, and making the voltage of the first node leap;
during a fourth stage, the driving module outputting a driving current through the third node under the control of a voltage input by the second level terminal and the voltage of the first node, and the electroluminescent module displaying a gray scale through the driving current under the control of a second scan signal input by the second scan signal terminal;
during a fifth stage, the gate signal terminal, the data signal terminal, the reset signal terminal, the first scan signal terminal and the second scan signal terminal inputting a touch driving signal, and the electroluminescent module stopping displaying the gray scale under the control of the touch driving signal input by the second scan signal terminal.

11. A display apparatus comprising the touch display circuit according to claim 1.

12. The circuit according to claim 3, wherein the charging module comprises a second transistor; and
a first terminal of the second transistor is connected to the second node, a second terminal of the second transistor is connected to the data signal terminal, and a gate of the second transistor is connected to the gate signal terminal.

13. The circuit according to claim 12, wherein the pull-up module comprises a third transistor and a capacitor;
a first terminal of the third transistor is connected to the second level terminal, a second terminal of the third transistor is connected to the second node, and a gate of the third transistor is connected to the first scan signal terminal; and
a first electrode of the capacitor is connected to the second node, and a second electrode of the capacitor is connected to the first node.

14. The circuit according to claim 13, wherein the driving module comprises a fourth transistor and a fifth transistor;
a first terminal of the fourth transistor is connected to the second level terminal, a second terminal of the fourth transistor is connected to the third node, and a gate of the fourth transistor is connected to the first node; and
a first terminal of the fifth transistor is connected to the first node, a second terminal of the fifth transistor is connected to the third node, and a gate of the fifth transistor is connected to the gate signal terminal.

15. The circuit according to claim 14, wherein the electroluminescent module comprises a sixth transistor and an OLED;
a first terminal of the sixth transistor is connected to the third node, a second terminal of the sixth transistor is connected to an anode of the OLED, and a gate of the sixth transistor is connected to the second scan signal terminal; and
a cathode of the OLED is connected to the third level terminal.

16. The circuit according to claim 15, wherein the third level terminal is a grounded level terminal.

17. The circuit according to claim 16, wherein all the transistors are N type transistors;
or all the transistors are P type transistors.

18. The display apparatus according to claim 11, wherein
during a display stage, the reset module is configured to pull the voltage of the first node to be equal to the voltage of the first level terminal under the control of a reset signal input by the reset signal terminal; the charging module is configured to pull the voltage of the second node to be equal to the voltage of the data signal terminal under the control of a gate signal input by the gate signal terminal and a data signal input by the data signal terminal; the pull-up module is configured to pull the voltage of the second node to be equal to the voltage of the second level terminal under the control of a first scan signal input by the first scan signal terminal, and make the voltage of the first node leap; the driving module is configured to pull the voltage of the first node to be equal to the voltage of the third node under the control of the gate signal input by the gate signal terminal, or output a driving current through the third node under the control of a voltage input by the second level terminal and the voltage of the first node; the electroluminescent module is configured to display a gray scale through the driving current under the control of a second scan signal input by the second scan signal terminal;
during a touch stage, the gate signal terminal, the data signal terminal, the reset signal terminal, the first scan signal terminal and the second scan signal terminal input a touch driving signal, and the electroluminescent module stops displaying the gray scale under the control of the touch driving signal input by the second scan signal terminal.

19. The display apparatus according to claim 18, wherein the reset module comprises a first transistor; and
a first terminal of the first transistor is connected to the first node, a second terminal of the first transistor is connected to the first level terminal, and a gate of the first transistor is connected to the reset signal terminal.

20. The display apparatus according to claim 18, wherein the charging module comprises a second transistor; and
a first terminal of the second transistor is connected to the second node, a second terminal of the second transistor is connected to the data signal terminal, and a gate of the second transistor is connected to the gate signal terminal.
